(19) United States
(12) Patent Application Publication
(10) Pub. No.: US 2016/0134365 A1
(43) Pub. Date: May 12, 2016

(54) Optical Signal Monitoring and Control Method, Signal Monitoring Apparatus and Optical Network System

(71) Applicant: Huawei Technologies Co., Ltd., Shenzhen (CN)

(72) Inventors: Ning Cheng, Santa Clara, CA (US); Degang Zhong, Shenzhen (CN); Zhenxing Liao, Wuhan (CN)

(21) Appl. No.: 14/981,256

(22) Filed: Dec. 28, 2015

Related U.S. Application Data
(63) Continuation of application No. PCT/CN2013/078502, filed on Jun. 29, 2013.

(51) Int. Cl. H04B 10/079; H04B 10/564

(52) U.S. Cl. CPC H04B 10/07955; H04B 10/564

(57) ABSTRACT

An optical signal monitoring and control method including receiving a first optical signal, performing optical-to-electrical conversion on the first optical signal, and outputting a converted first electrical signal, monitoring the first electrical signal, and acquiring a monitored power of the first electrical signal, adjusting the monitored power of the first electrical signal according to a target monitored power of the first electrical signal, and outputting a second electrical signal, and performing optical-to-electrical conversion on the second electrical signal according to a correspondence between the target monitored power of the first electrical signal and a target extinction ratio of the first optical signal, and outputting a converted second optical signal, where the second optical signal is an optical signal that has a target extinction ratio. The method implements precise control on an extinction ratio of an optical signal.

### CROSS-REFERENCE TO RELATED APPLICATIONS

This application is a continuation of International Application No. PCT/CN2013/078502, filed on Jun. 29, 2013, which is hereby incorporated by reference in its entirety.

### TECHNICAL FIELD

The present disclosure relates to the light field, and in particular, to an optical signal monitoring and control method, a signal monitoring apparatus and an optical network system.

### BACKGROUND

An extinction ratio of an optical signal on an optical network is a very important parameter. An excessively small extinction ratio causes a signal to noise ratio to become poor. As the signal to noise ratio becomes poor, a high-quality channel for transmitting an optical signal is required to make up for this defect. Consequently, the excessively small extinction ratio leads to an increase in costs of the channel for transmitting an optical signal. Moreover, an excessively large extinction ratio causes an increase in a chirp. As the chirp increases, a channel, having high dispersion performance, for transmitting an optical signal is required to make up for this defect. Consequently, the excessively large extinction ratio causes an increase in dispersion costs of the channel for transmitting an optical signal. Therefore, an extinction ratio of an optical signal needs to be precisely controlled.

### SUMMARY

Embodiments of the present disclosure provide an optical signal monitoring and control method, a signal monitoring apparatus and an optical network system, which can implement precise control on an extinction ratio of an optical signal.

According to a first aspect, an embodiment of the present disclosure provides an optical signal monitoring method, including receiving a first optical signal, performing optical-to-electrical conversion on the first optical signal, and outputting a converted first electrical signal; monitoring the first electrical signal, and acquiring a monitored power of the first electrical signal; adjusting the monitored power of the first electrical signal according to a target monitored power of the first electrical signal, and outputting a second electrical signal, so that a monitored power of the second electrical signal is the target monitored power; and performing optical-to-electrical conversion on the second electrical signal according to a correspondence between the target monitored power of the first electrical signal and a target extinction ratio of the first optical signal, and outputting a converted second optical signal, where the second optical signal is an optical signal that has a target extinction ratio.

In a first possible implementation manner of the first aspect, before the acquiring a monitored power of the first electrical signal, the method includes amplifying the first electrical signal, and performing power monitoring on the amplified first electrical signal.

With reference to any one of the foregoing implementation manners of the first aspect, in a second possible implementation manner of the first aspect, the acquiring a monitored power of the first electrical signal includes acquiring an average power of the first electrical signal and an alternating current power of the first electrical signal.

With reference to the second possible implementation manner of the first aspect, in a third possible implementation manner of the first aspect, the target monitored power of the first electrical signal includes a target average power of the first electrical signal and a target alternating current power of the first electrical signal.

With reference to the third possible implementation manner of the first aspect, in a fourth possible implementation manner of the first aspect, the adjusting the monitored power of the first electrical signal according to a target monitored power of the first electrical signal, and outputting a second electrical signal includes adjusting a bias current of the first electrical signal according to the target average power of the first electrical signal and the average power of the first electrical signal, so that the adjusted bias current of the first electrical signal is a target bias current; adjusting a modulation current of the first electrical signal according to the target alternating current power of the first electrical signal and the alternating current power of the first electrical signal, so that the adjusted modulation current of the first electrical signal is a target modulation current; and outputting the second electrical signal according to the target bias current and the target modulation current of the first electrical signal, where a bias current of the second signal is the target bias current, and a modulation current of the second signal is the target modulation current.

With reference to any one of the foregoing implementation manners of the first aspect, in a fifth possible implementation manner of the first aspect, the correspondence between the target monitored power of the first electrical signal and the target extinction ratio of the first optical signal is associated with a slope efficiency of the first optical signal.

According to a second aspect, an embodiment of the present disclosure provides a signal monitoring apparatus, including a photodiode, a monitoring unit, an adjusting unit, and an output unit, where the photodiode is configured to receive a first optical signal, perform optical-to-electrical conversion on the first optical signal, and output a converted first electrical signal; the monitoring unit is configured to monitor the first electrical signal, and acquire a monitored power of the first electrical signal; the adjusting unit is configured to adjust the monitored power of the first electrical signal according to a target monitored power of the first electrical signal, and output a second electrical signal, so that a monitored power of the second electrical signal is the target monitored power; and the output unit is configured to perform optical-to-electrical conversion on the second electrical signal according to a correspondence between the target monitored power of the first electrical signal and a target extinction ratio of the first optical signal, and output a converted second optical signal, where the second optical signal is an optical signal that has a target extinction ratio.

In a first possible implementation manner of the second aspect, the apparatus further includes an amplifier, where an input end of the amplifier is connected to an output end of the photodiode, an output end of the amplifier is connected to an input end of the monitoring unit, and the amplifier is configured to amplify the electrical signal, and perform power monitoring on the amplified electrical signal.

With reference to the first possible implementation manner of the second aspect, in a second possible implementation manner of the second aspect, the monitoring unit includes an average power monitoring unit and an alternating current power monitoring unit, where an input end of the average power monitoring unit is connected to the output end of the amplifier, and the average power monitoring unit is configured to acquire an average power of the first electrical signal; and an input end of the alternating current power monitoring unit is connected to the output end of the amplifier, and the alternating current power monitoring unit is configured to acquire an alternating current power of the first electrical signal.

With reference to the second possible implementation manner of the second aspect, in a third possible implementation manner of the second aspect, the target monitored power of the first electrical signal includes a target average power of the first electrical signal and a target alternating current power of the first electrical signal.

With reference to the third possible implementation manner of the second aspect, in a fourth possible implementation manner of the second aspect, the adjusting unit includes a bias current adjusting unit and a modulation current adjusting unit, where an input end of the bias current adjusting unit is connected to an output end of the average power monitoring unit, and the bias current adjusting unit is configured to adjust a bias current of the first electrical signal according to the target average power of the first electrical signal and the average power of the first electrical signal, so that the adjusted bias current of the first electrical signal is a target bias current; an input end of the modulation current adjusting unit is connected to an output end of the alternating current power monitoring unit, and the modulation current adjusting unit is configured to adjust a modulation current of the first electrical signal according to the target alternating current power of the first electrical signal and the alternating current power of the first electrical signal, so that the adjusted modulation current of the first electrical signal is a target modulation current; and an output subunit is configured to output the second electrical signal according to the target bias current and the target modulation current of the first electrical signal, where a bias current of the second signal is the target bias current, and a modulation current of the second signal is the target modulation current.

With reference to the fourth possible implementation manner of the second aspect, in a fifth possible implementation manner of the second aspect, the output subunit includes a bias current source and a modulation current source, where the bias current source is configured to output the target bias current; and the modulation current source is configured to output the target modulation current.

With reference to the fifth possible implementation manner of the second aspect, in a sixth possible implementation manner of the second aspect, the bias current adjusting unit includes a first comparator, a first input end of the first comparator is connected to the output end of the average power monitoring unit, a second input end of the first comparator is connected to a first reference value used for denoting the target average power of the first electrical signal, an output end of the first comparator is connected to the bias current source, and the first comparator is configured to adjust, according to the target average power of the first electrical signal and the average power of the first electrical signal, a current that is output by the bias current source, so that the current that is output by the bias current source is the target bias current.

With reference to the fifth possible implementation manner or the sixth possible implementation manner of the second aspect, in a seventh possible implementation manner of the second aspect, the modulation current adjusting unit includes a second comparator, a first input end of the second comparator is connected to the output end of the alternating current power monitoring unit, a second input end of the second comparator is connected to a second reference value used for denoting the target alternating current power of the first electrical signal, an output end of the second comparator is connected to the modulation current source, and the second comparator is configured to adjust, according to the target average power of the first electrical signal and the average power of the first electrical signal, a current that is output by the modulation current source, so that the current that is output by the modulation current source is the target modulation current.

According to a third aspect, an embodiment of the present disclosure provides an optical network system, where the optical network system includes an optical line terminal and an optical network unit, where the optical line terminal is connected to the optical network unit by using an optical distribution network, and the optical line terminal includes the signal monitoring apparatus in any one of the foregoing implementation manners of the second aspect, and/or the optical network unit includes the signal monitoring apparatus in any one of the foregoing implementation manners of the second aspect.

In the foregoing technical solutions, a first optical signal is received, optical-to-electrical conversion is performed on the first optical signal, and a converted first electrical signal is output; the first electrical signal is monitored, and a monitored power of the first electrical signal is acquired; the monitored power of the first electrical signal is adjusted according to a target monitored power of the first electrical signal, and a second electrical signal is output, so that a monitored power of the second electrical signal is the target monitored power; and optical-to-electrical conversion is performed on the second electrical signal according to a correspondence between the target monitored power of the first electrical signal and a target extinction ratio of the first optical signal, and a converted second optical signal is output, where the second optical signal is an optical signal that has a target extinction ratio. In this way, precise control on an extinction ratio of an optical signal can be implemented on the basis of precise control on a monitored power.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic flowchart of an optical signal monitoring and control method according to an embodiment of the present disclosure;

FIG. 2 is a schematic flowchart of another optical signal monitoring and control method according to an embodiment of the present disclosure;

FIG. 3 to FIG. 5 are schematic diagrams of optional correspondences according to embodiments of the present disclosure;

FIG. 6 is a schematic structural diagram of a signal monitoring apparatus according to an embodiment of the present disclosure;

FIG. 7 is a schematic structural diagram of another signal monitoring apparatus according to an embodiment of the present disclosure;

FIG. 8 is a schematic structural diagram of another signal monitoring apparatus according to an embodiment of the present disclosure;

FIG. 9 is a schematic structural diagram of another signal monitoring apparatus according to an embodiment of the present disclosure;

FIG. 10 is a schematic structural diagram of another signal monitoring apparatus according to an embodiment of the present disclosure;

FIG. 11 is a schematic structural diagram of another signal monitoring apparatus according to an embodiment of the present disclosure; and

FIG. 12 is a schematic structural diagram of an optical network system according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

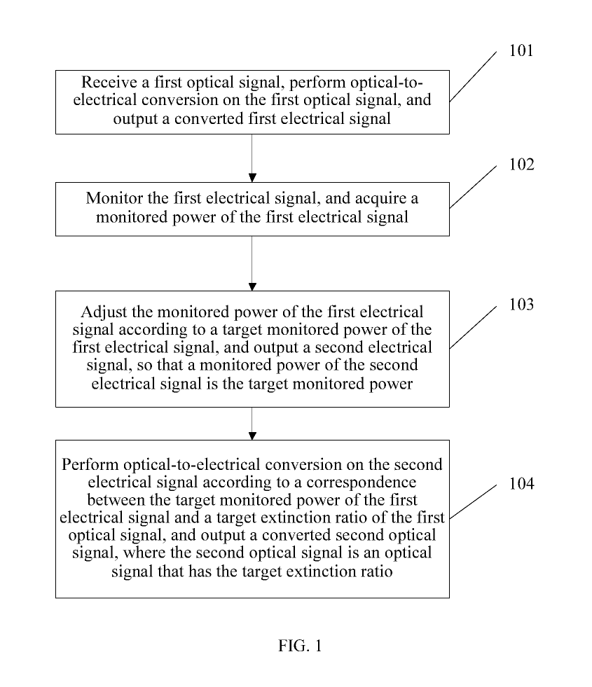

FIG. 1 is a schematic flowchart of an optical signal monitoring and control method according to an embodiment of the present disclosure. As shown in FIG. 1, the method includes the following steps:

101: Receive a first optical signal, perform optical-to-electrical conversion on the first optical signal, and output a converted first electrical signal.

Specifically, a photodiode may perform optical-to-electrical conversion on the first optical signal, and output the first electrical signal, for example, a current signal.

102: Monitor the first electrical signal, and acquire a monitored power of the first electrical signal.

Specifically, an average power and an alternating current power of the first electrical signal may be acquired.

103: Adjust the monitored power of the first electrical signal according to a target monitored power of the first electrical signal, and output a second electrical signal, so that a monitored power of the second electrical signal is the target monitored power.

That is, the first electrical signal is adjusted to obtain the second electrical signal. Specifically, a current or a voltage of the first electrical signal may be adjusted.

104: Perform optical-to-electrical conversion on the second electrical signal according to a correspondence between the target monitored power of the first electrical signal and a target extinction ratio of the first optical signal, and output a converted second optical signal, where the second optical signal is an optical signal that has a target extinction ratio.

The correspondence exists between the target monitored power of the first electrical signal and the target extinction ratio of the first optical signal, and therefore, when the monitored power of the second electrical signal is the target monitored power, an extinction ratio of the second optical signal obtained after the conversion from the second electrical signal is the target extinction ratio. That is, according to the correspondence between the target monitored power of the first electrical signal and the target extinction ratio of the first optical signal, the extinction ratio of the second optical signal can be determined by using the monitored power of the second electrical signal, and conversely, the monitored power of a monitored signal of the second electrical signal can be determined by using the extinction ratio of the second optical signal.

The extinction ratio may be specifically a ratio of a power generated by the first electrical signal when a pulse level for controlling emitting of an optical signal is a high level (for example, “1”) to a power generated by the first electrical signal when the pulse level is a low level (for example, “0”).

The method may be applied to any device that can send an optical signal, for example, a laser.

In the foregoing technical solution, a first optical signal is received, optical-to-electrical conversion is performed on the first optical signal, and a converted first electrical signal is output; the first electrical signal is monitored, and a monitored power of the first electrical signal is acquired; the monitored power of the first electrical signal is adjusted according to a target monitored power of the first electrical signal, and a second electrical signal is output, so that a monitored power of the second electrical signal is the target monitored power; and optical-to-electrical conversion is performed on the second electrical signal according to a correspondence between the target monitored power of the first electrical signal and a target extinction ratio of the first optical signal, and a converted second optical signal is output, where the second optical signal is an optical signal that has a target extinction ratio. In this way, precise control on an extinction ratio of an optical signal can be implemented on the basis of precise control on a monitored power.

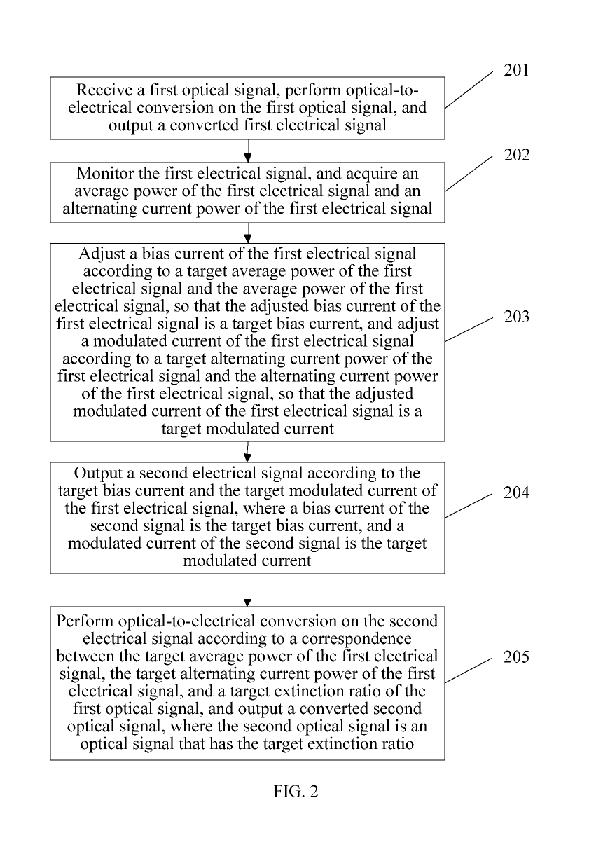

FIG. 2 is a schematic flowchart of another optical signal monitoring and control method according to an embodiment of the present disclosure. As shown in FIG. 2, the method includes the following steps:

201: Receive a first optical signal, perform optical-to-electrical conversion on the first optical signal, and output a converted first electrical signal.

Specifically, the electrical signal that is output in step 201 may be amplified, that is, before step 202, the method may further include amplifying the first electrical signal, and performing power monitoring on the amplified first electrical signal. That is, step 202 may be performing power monitoring on the amplified first electrical signal.

Specifically, a photodiode may perform optical-to-electrical conversion on the first optical signal, and an amplification circuit may amplify the first electrical signal. For example, optical-to-electrical conversion is performed on the first optical signal by using a monitor photodiode (MPD), and the first electrical signal is amplified by using a transimpedance amplifier (TIA), where the MPD may be specifically a low-rate monitor photodiode, and the first electrical signal after being amplified by the TIA may be specifically a voltage signal.

202: Monitor the first electrical signal, and acquire an average power of the first electrical signal and an alternating current power of the first electrical signal.

The acquiring an alternating current power of the first electrical signal may specifically include performing filtering on the amplified first electrical signal, and acquiring an alternating current power of the first electrical signal that undergoes filtering. That is, filtering is performed on the first electrical signal amplified in step 201, where the first electrical signal that undergoes filtering is an alternating current signal. In this way, a calculated power of the first electrical signal that undergoes filtering is an alternating current power, that is, the alternating current power of the amplified first electrical signal is obtained. The filtration may be specifically performing filtering on the monitored signal by using a band-pass filter (BPF), a high-pass filter, or a coupling capacitor, that is, blocking a direct current power of the first electrical signal and obtaining the alternating current power of the monitored signal.

203: Adjust a bias current of the first electrical signal according to a target average power of the first electrical signal and the average power of the first electrical signal, so that the adjusted bias current of the first electrical signal is a target bias current; and adjust a modulation current of the first electrical signal according to a target alternating current power of the first electrical signal and the alternating current power of the first electrical signal, so that the adjusted modulation current of the first electrical signal is a target modulation current.

204: Output a second electrical signal according to the target bias current and the target modulation current of the first electrical signal, where a bias current of the second signal is the target bias current, and a modulation current of the second signal is the target modulation current.

Specifically, a correspondence may exist between the target average power and the target bias current, and in this way, the average power of the first electrical signal may be adjusted to the target average power according to the target average power of the first electrical signal. From the one-to-one correspondence between the target average power and the target bias current of the first electrical signal, it can be known that, when the average power of the first electrical signal is adjusted to the target average power, the bias current that is output by the first electrical signal is the target bias current. A correspondence exists between the target alternating current power and the target modulation current, and in this way, the alternating current power of the first electrical signal may be adjusted to the target alternating current power according to the target alternating current power of the first electrical signal. From the one-to-one correspondence between the target alternating current power and the target modulation current of the first electrical signal, it can be known that, when the alternating current power of the first electrical signal is adjusted to the target alternating current power, the modulation current that is output by the first electrical signal is the target modulation current.

205: Perform optical-to-electrical conversion on the second electrical signal according to a correspondence between the target average power of the first electrical signal and the target alternating current power of the first electrical signal and a target extinction ratio of the first optical signal, and output a converted second optical signal, where the second optical signal is an optical signal that has a target extinction ratio.

That is, the target monitored power of the first electrical signal in the foregoing embodiment may specifically include the target average power of the first electrical signal and the target alternating current power of the first electrical signal. The correspondence between the target monitored power of the first electrical signal and the target extinction ratio of the first optical signal may specifically include the correspondence between the target average power of the first electrical signal and the target alternating current power of the first electrical signal and the target extinction ratio of the first optical signal.

The correspondence between the target average power of the first electrical signal and the target alternating current power of the first electrical signal and the target extinction ratio of the first optical signal may be specifically shown in the following expression:

$${P}_{mod} = K \frac{{r}_{e}}{{r}_{e} + 1} ,$$

where P_{mod} is the target average power of the first electrical signal, rₑ is the target extinction ratio of the first optical signal, and K is a constant that varies according to the target average power of the first electrical signal, that is, when the target average power of the first electrical signal remains the same, K is a constant, where K may be specifically shown in the following expression:

$$K = 2 {AP}_{avg} = 2 {P}_{avg} {\int }_{- ∞}^{∞} \frac{{R}_{t} R}{4 {T}_{b}} {\vert H ( f ) \vert}^{2} {\vert G ( f ) \vert}^{2} ,$$

where P_{avg} is the target average power of the first electrical signal, T_{b} is an element cycle, f is a frequency of the first electrical signal, H(f) is a filter frequency of the BPF, G(f) is a spectrum of the first electrical signal (that is, Fourier transformation of a pulse of the first electrical signal), R may be specifically a responsivity of the MPD that monitors the first electrical signal, and Rₜ may be specifically a transimpedance of the TIA that monitors the first electrical signal.

For example, a power of the first optical signal is shown in the following expression:

$${P}_{laser} ( t ) = {\sum }_{k = - ∞}^{∞} {a}_{k} {P}_{1} g ( t ) + {P}_{0} ,$$

where Pₗₐₛₑᵣ(t) is the power of the first optical signal, aₖ={0, 1} represents binary data, P₁ is a power of a bit “1”, P₀ is a power of a bit “0”, and g(t) represents a pulse of the sent signal. Assuming that the responsivity of the MPD is R, the first electrical signal may be shown in the following:

$$I ( t ) = {RP}_{laser} ( t ) = R {\sum }_{k = - ∞}^{∞} {a}_{k} {P}_{1} g ( t ) + {P}_{0} ,$$

where I(t) is the first electrical signal, and R is the responsivity of the MPD.

Assuming that the transimpedance of the TIA is Rₜ, the first electrical signal after being amplified by the TIA may be shown in the following expression:

$$V ( t ) = {R}_{t} I ( t ) = {R}_{t} R {\sum }_{k = - ∞}^{∞} {a}_{k} {P}_{1} g ( t ) + {P}_{0} ,$$

where V(t) represents the amplified first electrical signal.

When the filtration is implemented by using the band-pass filter, because the MPD generally has a low-pass frequency response H_{MPD}(f), assuming that the MPD has an ideal response, the frequency response of the MPD is merged into the band-pass filter, and H(f)=H_{MPD}(f)·H_{TIA}(f)·H_{BPF}(f), where H_{BPF}(f) is a frequency response of the band-pass filter, and H_{TIA}(f) is a frequency response of the transimpedance amplifier.

Corresponding to random binary data such as binary data irrelevant to aₖ, a power spectral density of the first electrical signal V(t) may be shown in the following expression:

$${S}_{v} ( f ) = \frac{{R}_{t} {RP}_{1}}{4 {T}_{b}} {\vert G ( f ) \vert}^{2} + \frac{{R}_{t} {RP}_{1}}{4 {T}_{b}^{2}} {\sum }_{m = - ∞}^{∞} {\vert G ( \frac{m}{{T}_{b}} ) \vert}^{2} δ ( f - \frac{m}{{T}_{b}} ) + {R}_{t} R {P}_{0} δ ( f ) ,$$

where Sᵥ(f) is the power spectral density of the first electrical signal V(t), f is the frequency of the first electrical signal, T_{b} is the element cycle, G(f) is the spectrum of the signal pulse, m is an integer, and δ(f) is a unit pulse response function, for example, a Dirac function.

For the first electrical signal V(t), a power spectral density after the filtering performed by the BPF may be shown in the following expressions:

$${S}_{BPF} ( f ) = {\vert H ( f ) \vert}^{2} {S}_{v} ( f ) and$$

$${S}_{BPF} ( f ) = {\vert H ( f ) \vert}^{2} [ \frac{{R}_{t} {RP}_{1}}{4 {T}_{b}} {\vert G ( f ) \vert}^{2} + \frac{{R}_{t} {RP}_{1}}{4 {T}_{b}^{2}} {\sum }_{m = - ∞}^{∞} {\vert G ( \frac{m}{{T}_{b}} ) \vert}^{2} δ ( f - \frac{m}{{T}_{b}} ) + {R}_{t} R {P}_{0} δ ( f ) ] ,$$

where H(f) is the filter frequency of the BPF.

Specifically, a low cut-off frequency of the BPF may be set to be greater than 0, and a high cut-off frequency may be set to be less than a data rate; then the power spectral density obtained after the filtering performed by the BPF may be shown in the following expression:

$${S}_{BPF} ( f ) = \frac{{R}_{t} {RP}_{1}}{4 {T}_{b}} {\vert G ( f ) \vert}^{2} {\vert H ( f ) \vert}^{2} .$$

Then, the alternating current power of the first electrical signal may be obtained by using the power spectral density obtained after the filtering performed by the BPF, and may be shown in the following expression:

$${P}_{mod} = {\int }_{- ∞}^{∞} \frac{{R}_{t} {RP}_{1}}{4 {T}_{b}} {\vert H ( f ) \vert}^{2} {\vert G ( f ) \vert}^{2} = {AP}_{1} ,$$

where P_{mod} is the alternating current power of the first electrical signal, and A may be shown in the following expression:

$$A = {\int }_{- ∞}^{∞} \frac{{R}_{t} R}{4 {T}_{b}} {\vert H ( f ) \vert}^{2} {\vert G ( f ) \vert}^{2} .$$

That is, corresponding to the given MPD, TIA and BPF, A may be obtained, that is, A may be a constant. Therefore, the alternating current power P_{mod} of the amplified first electrical signal is in proportion to the power P₁ of “1”, and the average power P_{avg} of the first electrical signal, the power P₁ of “1”, and the extinction ratio rₑ meet the following relationship:

$${P}_{1} = 2 {P}_{avg} \frac{{r}_{e}}{{r}_{e} + 1} .$$

That is, it may be obtained that, the alternating current power P_{mod} of the first electrical signal, the average power P_{avg} of the first electrical signal, and the extinction ratio rₑ meet the following relationship:

$${P}_{mod} = 2 {AP}_{avg} \frac{{r}_{e}}{{r}_{e} + 1} = K \frac{{r}_{e}}{{r}_{e} + 1} .$$

That is, it may be obtained that, the correspondence between the target average power of the first electrical signal and the target alternating current power of the first electrical signal and the target extinction ratio of the first optical signal may be specifically shown in the following expression:

$${P}_{mod} = K \frac{{r}_{e}}{{r}_{e} + 1} .$$

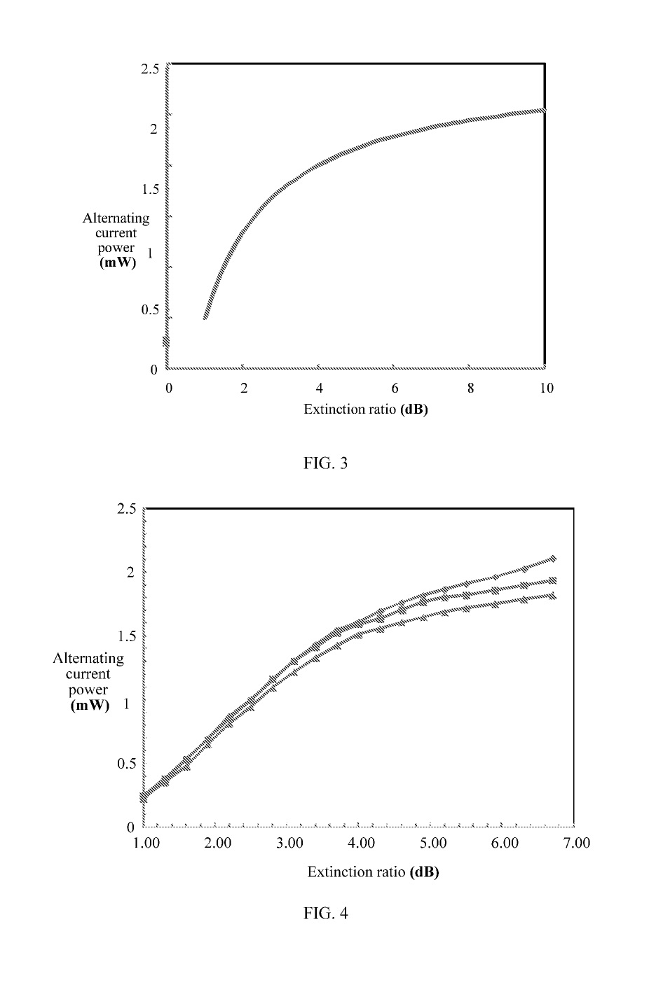

The correspondence between the target average power of the first electrical signal and the target alternating current power of the first electrical signal and the target extinction ratio of the first optical signal may be shown in FIG. 3. As shown in the figure, a one-to-one correspondence exists between the extinction ratio of the first electrical signal and the alternating current power of the first electrical signal. Therefore, the alternating current power may be used to monitor and control the extinction ratio. During normal work, the alternating current power may be continuously monitored and be compared with a first reference value. If a difference exists between a measured value and the first reference value, the modulation current is adjusted until the measured value is equal to the reference value. Specifically, the first reference value may be preset; in step 203, the alternating current power is adjusted and is compared with the first reference value, and then the modulation current is adjusted according to a comparison result. In addition, a second reference value may be further preset; in step 203, the average power is adjusted and is compared with the second reference value, and then the bias current is adjusted according to a comparison result.

For a given extinction ratio, if slope efficiencies of optical signal sending devices are different, coupling efficiencies between the optical signal sending devices and the MPD are different, duty cycles of modulated signals are different, and an TIA gains are different, measured alternating current power varies to some extent. FIG. 4 shows test results of three different 10 gigabits per second (Gbps) directly modulated lasers (DML). To precisely control the extinction ratio, a relationship between the alternating current power and the extinction ratio needs to be calibrated for a specific DML transceiver. An extinction ratio of a monitored optical signal is calibrated before step 201, and a calibrated reference value (for example, the first reference value or the second reference value) is stored in a memory, so to be used during normal operation. Certainly, multiple reference values corresponding to multiple different target extinction ratios may be stored. The following provides description by using a specific calibration example. Certainly, a calibration manner is not limited in this embodiment.

For example, calibration of the extinction ratio and the average power P_{avg} may be performed when the DML transceiver is powered on, a current Iₗₐₛₑᵣ of an optical signal sent by a laser is swept from 0 to a specific value (a maximum working current of the DML). In addition, the average power P_{avg} is measured and recorded, and is recorded as P_{avg}(Iₗₐₛₑᵣ) based on a relationship function between the measured P_{avg} and Iₗₐₛₑᵣ. For a target extinction ratio E_{Rtarget}, a modulation current I_{mod} and a bias current I_{B} may be determined, and then, the average power P_{avg} corresponding to the target extinction ratio ER_{target} may be determined, where the average power P_{avg} may be used as the first reference value for adjusting the average power of the monitored signal. For example, for a given bias current I_{B} of the laser (a bias current of the DML is determined by the average optical power), an extinction ratio may be determined by using a given modulation current, and then, a correspondence between the modulation current and the extinction ratio may be obtained. The alternating current power and the modulation current of the monitored signal satisfy the correspondence; in this way, the alternating current power of the monitored signal can be adjusted by adjusting the modulation current, so as to adjust the extinction ratio of the optical signal. For example, if a modulation current is I_{mod}, a measured optical power P _{1avg}(I_{B}+0.5·I_{mod}) of a corresponding bit “1” may be determined by using a relationship curve between P_{avg} and Iₗₐₛₑᵣ. A measured optical power P_{0avg}(I_{B}−0.5·I_{mod}) of a corresponding bit “0” may also be determined by using a similar method. Then the extinction ratio may be simply represented as E_{R}=P_{1avg}(I_{B}+0.5·I_{mod})/P_{0avg}(I_{B}−0.5·I_{mod}). Conversely, if an extinction ratio is given, the modulation current I_{mod} may be determined by using the relationship curve between P_{avg} and Iₗₐₛₑᵣ or the slope efficiency. After I_{mod} is determined, the laser can work in a normal mode. In this case, a corresponding extinction ratio value and a measured P_{mod} are used as the second reference value P_{mod,ref}, and in step 203, the alternating current power of the monitored signal may be adjusted by using the second reference value P_{mod,ref}.

As an optional implementation manner, the correspondence between the target monitored power of the first electrical signal and the target extinction ratio of the first optical signal is associated with a slope efficiency of the first optical signal. That is, for different slope efficiencies, correspondences between the target monitored power of the first electrical signal and the target extinction ratio of the first optical signal are different. The slope efficiency may be specifically a value of an optical power that is converted from a unit current greater than a threshold, and specifically, may be a value of an optical power of the first optical signal that is converted from the bias current and/or a value of an optical power of the first optical signal that is converted from the modulation current. A specific correspondence exists between the optical power of the first optical signal and the monitored power of the first electrical signal. Specifically, reference may be made to the foregoing formulas. In this way, the slope efficiency may be used to monitor a relationship among the bias current, the modulation current, and the monitored power of the first electrical signal; a specific correspondence exists between the bias current and the modulation current and the extinction ratio of the first optical signal, and therefore, the correspondence between the target monitored power of the first electrical signal and the target extinction ratio of the first optical signal is associated with the slope efficiency of the first optical signal. That is, in this embodiment, the correspondence between the target monitored power of the first electrical signal and the target extinction ratio of the first optical signal may be calibrated according to the slope efficiency of the first electrical signal, and the calibration may be performed in the following example.

For example, the second reference value P_{mod,ref} is the target alternating current power corresponding to the target extinction ratio, and then the second reference value P_{mod,ref} may be adjusted according to the slope efficiency. The following provides description by using a specific adjustment example. Certainly, an adjustment manner in which the second reference value P_{mod,ref} is adjusted is not limited in this embodiment. For example, in actual application, the slope efficiency of the DML may vary due to impact of a temperature variation or aging. When the slope efficiency of the DML varies, a relationship between P_{mod} and ER_{target} may not vary or may vary very slightly. To calibrate a variation of the slope efficiency during normal work, the second reference value P_{mod,ref} for adjusting the target alternating current power of the first electrical signal needs to be calibrated during the normal work. This may be implemented by slightly adjusting the bias current. For example, if the bias current I_{B} of the first electrical signal is increased to make ΔI_{B}=5 mA, an output power is also slightly increased, which does not affect a power budget and normal work of a receiver that is configured to receive an optical signal. When the bias current is set to I_{B} and I_{B}+ΔI_{B}, corresponding P_{avg}(I_{B}) and P_{avg}(I_{B}+ΔI_{B}) may be measured. From these two points, a relationship between P_{avg} and I_{B} may be determined, and for a given target extinction ratio of the first electrical signal, the modulation current I_{mod} of the first electrical signal may also be determined. Then the modulation current may be set to a new determined value, and a value of P_{mod} is measured and is used as a new second reference value P_{mod,ref}. A linear relationship between P_{avg} and I_{B} may also be obtained through multipoint measurement. For example, the linear relationship between P_{avg} and I_{B} may also be determined by measuring powers P_{avg}(I_{B}), P_{avg}(I_{B}+ΔI_{B1}) and P_{avg}(I_{B}+ΔI_{B2}) of three points. Because the calibration is based on assumption about a linear relationship between a DML output power and a bias current (this relationship is generally true when the laser works above a threshold and below a maximum current), when the modulation current is less than the threshold for the laser, the laser cannot work. When a working rate is 10 Gbps or above, to avoid a switch delay problem, the modulation current generally cannot be less than the threshold. Therefore, the assumption about the linear relationship is true.

In another embodiment, because the correspondence between the target average power of the first electrical signal and the target alternating current power of the first electrical signal and the target extinction ratio of the first optical signal meets the following relationship:

$${P}_{mod} = K \frac{{r}_{e}}{{r}_{e} + 1} .$$

In actual application, a drastic variation of the extinction ratio causes a slight variation of the alternating current power of the first electrical signal. Therefore, when the extinction ratio is relatively large, an error is caused when the relationship, shown in the foregoing expression, between the extinction ratio and the alternating current power of the first electrical signal is used. In an ideal case, a linear relationship between a measurement parameter and a control parameter is relatively good. Specifically, the alternating current power of the first electrical signal may be multiplied by (r_{e,target}+1), where r_{e,target} is the target extinction ratio, and then the following expression may be obtained:

$$( {r}_{e , target} + 1 ) \cdot {P}_{mod} = K \frac{{r}_{e}}{{r}_{e} + 1} ( {r}_{e , target} + 1 ) \approx {Kr}_{e} .$$

That is, (r_{e,target}+1)·P_{mod} and the extinction ratio of the first optical signal have a linear relationship, which may be specifically shown in FIG. 5. In this way, in step 203, the adjusting a modulation current of the first electrical signal according to a target alternating current power of the first electrical signal and the alternating current power of the first electrical signal, so that the adjusted modulation current of the first electrical signal is a target modulation current may include adjusting the modulation current of the first electrical signal according to the target alternating current power of the first electrical signal and a multiplication alternating current power of the first electrical signal, so that the adjusted modulation current of the first electrical signal is the target modulation current. The multiplication alternating current power is an alternating current power obtained by multiplying the alternating current power of the first electrical signal by (r_{e,target}+1). The multiplication alternating current power and the extinction ratio have a linear relationship, and therefore, the extinction ratio may be better controlled by using the multiplication alternating current power.

In the foregoing technical solution, on the basis of the foregoing embodiment, multiple optional implementation manners are implemented, in all of which precise control on an extinction ratio can be implemented.

The following are apparatus embodiments of the present disclosure, and the apparatus embodiments of the present disclosure are used to execute the methods implemented in Method Embodiments 1 and 2 of the present disclosure. For ease of description, only parts related to the embodiments of the present disclosure are shown. For specific technical details that are not disclosed, reference is made to Embodiment 1 and Embodiment 2 of the present disclosure.

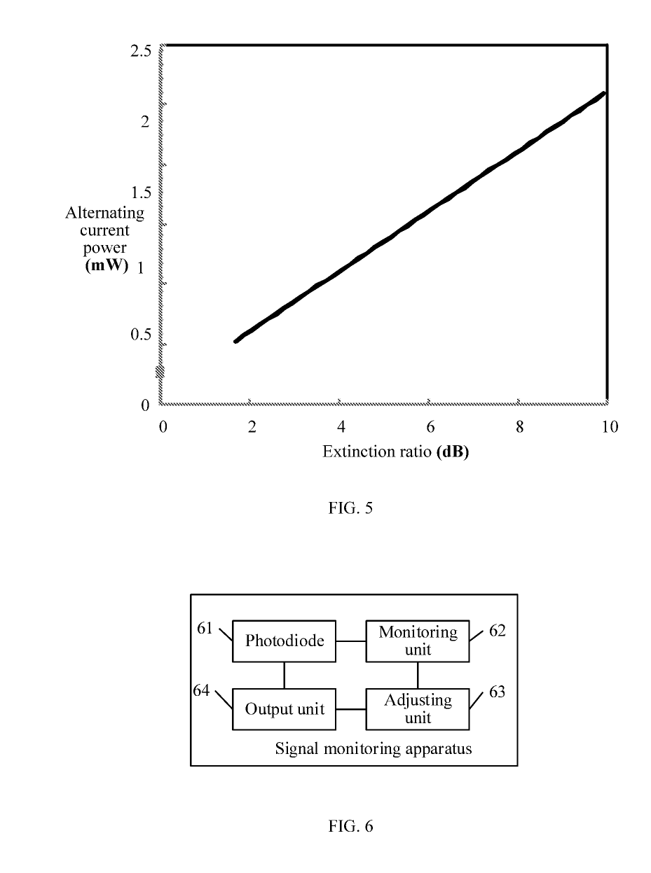

FIG. 6 is a schematic structural diagram of a signal monitoring apparatus according to an embodiment of the present disclosure. As shown in FIG. 6, the apparatus includes a photodiode 61, a monitoring unit 62, an adjusting unit 63, and an output unit 64.

The photodiode 61 is configured to receive a first optical signal, perform optical-to-electrical conversion on the first optical signal, and output a converted first electrical signal.

Specifically, the photodiode 61 may convert the first optical signal into an electrical signal, so as to obtain the first electrical signal.

The monitoring unit 62 is configured to monitor the first electrical signal, and acquire a monitored power of the first electrical signal.

Specifically, an average power and an alternating current power of the first electrical signal may be calculated, where the first optical signal may be specifically an optical signal that is obtained by performing optical-to-electrical conversion on the first electrical signal.

The adjusting unit 63 is configured to adjust the monitored power of the first electrical signal according to a target monitored power of the first electrical signal, and output a second electrical signal, so that a monitored power of the second electrical signal is the target monitored power.

That is, the first electrical signal is adjusted to obtain the second electrical signal, and specifically, a current or a voltage of the first electrical signal may be adjusted.

The output unit 64 is configured to perform optical-to-electrical conversion on the second electrical signal according to a correspondence between the target monitored power of the first electrical signal and a target extinction ratio of the first optical signal, and output a converted second optical signal, where the second optical signal is an optical signal that has a target extinction ratio.

The correspondence exists between the target monitored power of the first electrical signal and the target extinction ratio of the first optical signal, and therefore, when the monitored power of the second electrical signal is the target monitored power, an extinction ratio of the second optical signal obtained after the conversion from the second electrical signal is the target extinction ratio. That is, according to the correspondence between the target monitored power of the first electrical signal and the target extinction ratio of the first optical signal, the extinction ratio of the second optical signal can be determined by using the monitored power of the second electrical signal, and conversely, the monitored power of a monitored signal of the second electrical signal can be determined by using the extinction ratio of the second optical signal.

The extinction ratio may be specifically a ratio of a power generated by the first electrical signal when a pulse level for controlling emitting of an optical signal is a high level (for example, “1”) to a power generated by the first electrical signal when the pulse level is a low level (for example, “0”).

The apparatus may be applied to any device, for example, a laser that can send an optical signal.

In the foregoing technical solution, a first optical signal is received, optical-to-electrical conversion is performed on the first optical signal, and a converted first electrical signal is output; the first electrical signal is monitored, and a monitored power of the first electrical signal is acquired; the monitored power of the first electrical signal is adjusted according to a target monitored power of the first electrical signal, and a second electrical signal is output, so that a monitored power of the second electrical signal is the target monitored power; and optical-to-electrical conversion is performed on the second electrical signal according to a correspondence between the target monitored power of the first electrical signal and a target extinction ratio of the first optical signal, and a converted second optical signal is output, where the second optical signal is an optical signal that has a target extinction ratio. In this way, precise control on an extinction ratio of an optical signal can be implemented on the basis of precise control on a monitored power.

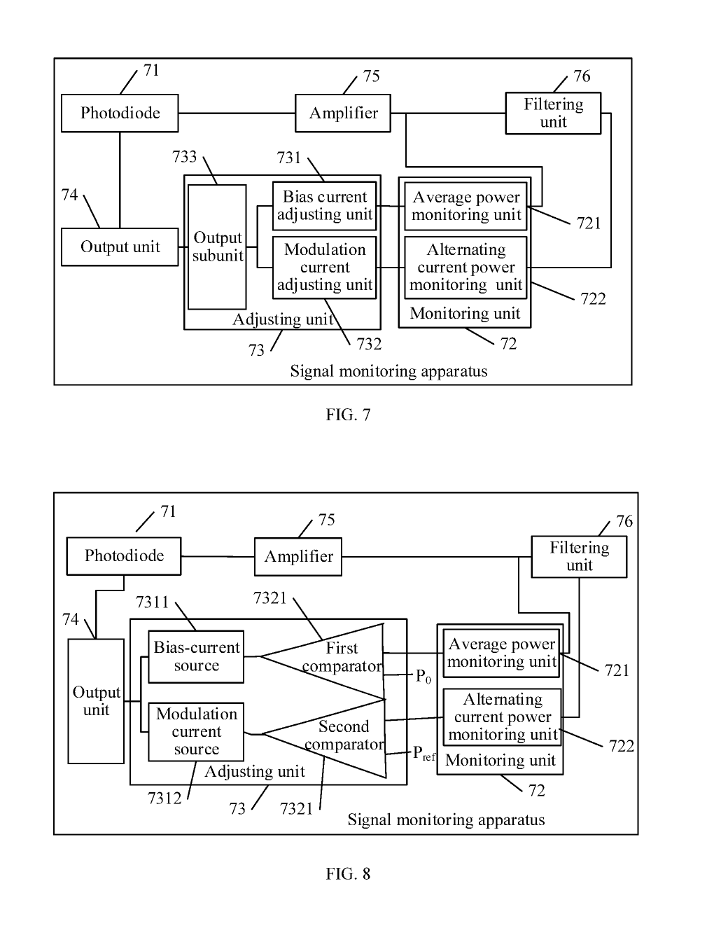

FIG. 7 is a schematic structural diagram of another signal monitoring apparatus according to an embodiment of the present disclosure. As shown in FIG. 7, the apparatus includes a photodiode 71, a monitoring unit 72, an adjusting unit 73, and an output unit 74, where the monitoring unit 72 includes an average power monitoring unit 721 and an alternating current power monitoring unit 722, and the adjusting unit 73 includes a bias current adjusting unit 731, a modulation current adjusting unit 732, and an output subunit 733.

The photodiode 71 is configured to receive a first optical signal, perform optical-to-electrical conversion on the first optical signal, and output a converted first electrical signal.

The apparatus may further include an amplifier 75, where an input end of the amplifier 75 is connected to an output end of the photodiode 71, an output end of the amplifier 75 is connected to an input end of the monitoring unit 72, and the amplifier 75 is configured to amplify the electrical signal, and perform power monitoring on the amplified electrical signal. That is, the monitoring unit 72 may perform power monitoring on the amplified first electrical signal. The amplifier 75 may be specifically a TIA, and the photodiode 71 may be specifically an MPD.

The average power monitoring unit 721 is configured to acquire an average power of the first electrical signal, where an input end of the average power monitoring unit 721 may be specifically connected to the output end of the photodiode 71, or an input end of the average power monitoring unit 721 may be specifically connected to the output end of the amplifier 75.

The alternating current power monitoring unit 722 is configured to acquire an alternating current power of the first electrical signal, where an input end of the alternating current power monitoring unit 722 may be specifically connected to the output end of the photodiode 71, or an input end of the alternating current power monitoring unit 722 may be specifically connected to the output end of the amplifier 75.

Optionally, the apparatus may further include a filtering unit 76, where the filtering unit 76 is configured to perform filtering on the first electrical signal, where an input end of the filtering unit 76 is connected to the output end of the photodiode 71, or an input end of the filtering unit 76 is connected to the output end of the amplifier 75, an output end of the filtering unit 76 is connected to the input end of the alternating current power monitoring unit 722, and the alternating current power monitoring unit 722 may be further configured to acquire the alternating current power of the first electrical signal that undergoes filtering.

The filtering unit 76 may be specifically a BPF or a high-pass filter, or filter a monitored signal by using a coupling capacitor, that is, block a direct current power of the monitored signal to obtain alternating current power of the monitored signal.

An input end of the bias current adjusting unit 731 is connected to an output end of the average power monitoring unit 721, and the bias current adjusting unit 731 is configured to adjust a bias current of the first electrical signal according to a target average power of the first electrical signal and the average power of the first electrical signal, so that the adjusted bias current of the first electrical signal is a target bias current; an input end of the modulation current adjusting unit 732 is connected to an output end of the alternating current power monitoring unit 722, and the modulation current adjusting unit 732 is configured to adjust a modulation current of the first electrical signal according to a target alternating current power of the first electrical signal and the alternating current power of the first electrical signal, so that the adjusted modulation current of the first electrical signal is a target modulation current; and the output subunit 733 is configured to output a second electrical signal according to the target bias current and the target modulation current of the first electrical signal, where a bias current of the second signal is the target bias current, and a modulation current of the second signal is the target modulation current.

Specifically, a correspondence may exist between the target average power and the target bias current, and in this way, the average power of the first electrical signal may be adjusted to the target average power according to the target average power of the first electrical signal. From the one-to-one correspondence between the target average power and the target bias current of the first electrical signal, it can be known that, when the average power of the first electrical signal is adjusted to the target average power, the bias current that is output by the first electrical signal is the target bias current. A correspondence exists between the target alternating current power and the target modulation current, and in this way, the alternating current power of the first electrical signal may be adjusted to the target alternating current power according to the target alternating current power of the first electrical signal. From the one-to-one correspondence between the target alternating current power and the target modulation current of the first electrical signal, it can be known that, when the alternating current power of the first electrical signal is adjusted to the target alternating current power, the modulation current that is output by the first electrical signal is the target modulation current.

The output unit 74 is configured to perform optical-to-electrical conversion on the second electrical signal according to a correspondence between the target average power of the first electrical signal and the target alternating current power of the first electrical signal and a target extinction ratio of the first optical signal, and output a converted second optical signal, where the second optical signal is an optical signal that has a target extinction ratio.

In another embodiment, a correspondence between the target monitored power of the first electrical signal and the target extinction ratio of the first optical signal is associated with a slope efficiency of the first optical signal. That is, for a different slope efficiency, the correspondence between the target monitored power of the first electrical signal and the target extinction ratio of the first optical signal is different.

As an optional implementation manner, as shown in FIG. 8, the output subunit 733 includes a bias current source 7311 and a modulation current source 7332, where the bias current source 7311 is configured to output the target bias current, and may specifically receive an adjustment from the bias current adjusting unit 731, and output the target bias current; and the modulation current source 7312 is configured to output the target modulation current, and may specifically receive an adjustment from the modulation current adjusting unit 732, and output the target modulation current.

The second electrical signal may specifically include the target bias current and the target modulation current. That is, the second electrical signal may specifically include the target bias current that is output by the bias current source 7311 and the target modulation current that is output by the modulation current source 7312.

As an optional implementation manner, the bias current adjusting unit 731 may be specifically a first comparator 7321, where a first input end of the first comparator 7321 is connected to the output end of the average power monitoring unit 721, a second input end of the first comparator 7321 is connected to a first reference value P₀ used for denoting the target average power of the first electrical signal, an output end of the first comparator 7321 is connected to the bias current source 7311, and the first comparator 7321 is configured to adjust, according to the target average power of the first electrical signal and the average power of the first electrical signal, a current that is output by the bias current source 7311, so that the current that is output by the bias current source 7311 is the target bias current.

For the first reference value, reference may be made to the first reference value described in the foregoing method embodiments.

As an optional implementation manner, the modulation current adjusting unit 732 may be specifically a second comparator 7321, a first input end of the second comparator 7321 is connected to the output end of the alternating current power monitoring unit 722, a second input end of the second comparator 7321 is connected to a second reference value P_{ref} used for denoting the target alternating current power of the first electrical signal, an output end of the second comparator 7321 is connected to the modulation current source 7312, and the second comparator 7321 is configured to adjust, according to the target average power of the first electrical signal and the average power of the first electrical signal, a current that is output by the modulation current source 7312, so that the current that is output by the modulation current source 7312 is the target modulation current.

For the second reference value, reference may be made to the second reference value described in the foregoing method embodiments.

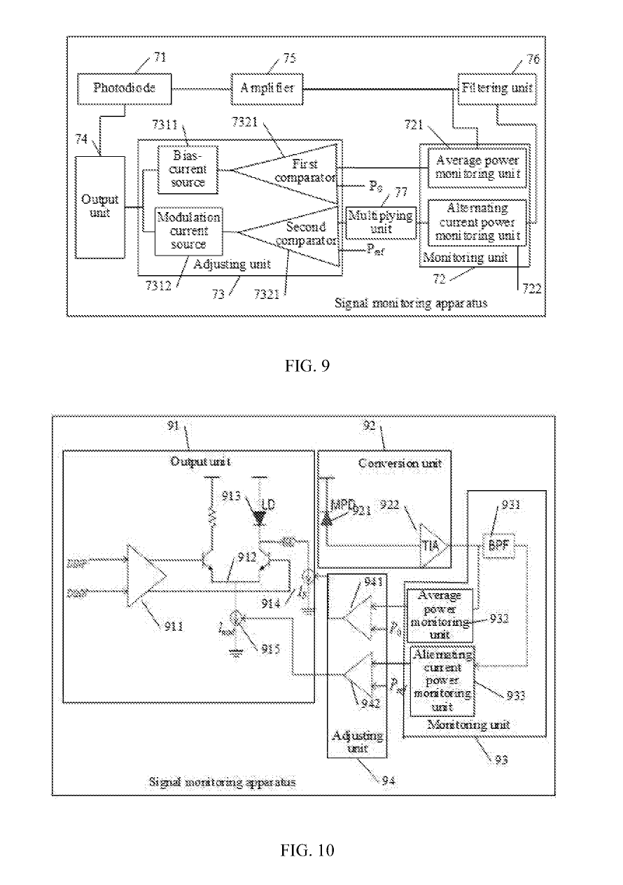

As an optional manner, as shown in FIG. 9, the circuit may further include a multiplying unit 77, where an input end of the multiplying unit 77 is connected to the output end of the alternating current power monitoring unit 722, an output end of the multiplying unit 77 is connected to the first input end of the second comparator 7321, and the multiplying unit 77 is configured to multiply the alternating current power, output by the output end of the alternating current power monitoring unit, of the first electrical signal by a target function, to obtain a multiplied alternating current power.

For example, the correspondence between the target average power of the first electrical signal and the target alternating current power of the first electrical signal and the target extinction ratio of the first optical signal meets the following relationship:

$${P}_{mod} = K \frac{{r}_{e}}{{r}_{e} + 1} .$$

For details about the relational expression, reference may be made to the relationship of the correspondence, described in the foregoing method embodiments, between the target average power of the first electrical signal and the target alternating current power of the first electrical signal and the target extinction ratio of the first optical signal, which is, and no repeated description is provided herein.

In actual application, a drastic variation of the extinction ratio causes a slight variation of the alternating current power of the first electrical signal. Therefore, when the extinction ratio is relatively large, an error is caused when the relationship, shown in the foregoing expression, between the extinction ratio and the alternating current power of the first electrical signal is used. In an ideal case, a linear relationship between a measurement parameter and a control parameter is relatively good. Specifically, the alternating current power of the first electrical signal may be multiplied by (r_{e,target}+1), that is, the multiplying unit 77 is further configured to multiply the alternating current power, output by the output end of the alternating current power monitoring unit, of the first electrical signal by the target function (r_{e,target}+1), to obtain a multiplied alternating current power (r_{e,target}+1)·P_{mod}, where

$$( {r}_{e , target} + 1 ) \cdot {P}_{mod} = K \frac{{r}_{e}}{{r}_{e} + 1} ( {r}_{e , target} + 1 ) \approx {Kr}_{e} .$$

That is, (r_{e,target}+1)·P_{mod} and the extinction ratio have a linear relationship, which may be specifically shown in FIG. 5. In this way, the second comparator 7321 may adjust the modulation current of the first electrical signal according to the target alternating current power of the first electrical signal and the multiplied alternating current power of the first electrical signal, so that the adjusted modulation current of the first electrical signal is the target modulation current.

In the foregoing technical solution, on the basis of the foregoing embodiment, multiple optional implementation manners are implemented, in all of which precise control on an extinction ratio can be implemented.

FIG. 10 is a schematic structural diagram of a signal monitoring apparatus according to an embodiment of the present disclosure. As shown in FIG. 10, the apparatus includes an output unit 91, a conversion unit 92, a monitoring unit 93, and an adjusting unit 94.

The output unit 91 includes a drive circuit 911, a switch circuit 912, a laser (Laser Diode, LD) 913, a bias current source I_{B}914, and a modulation current source I_{mod}915.

An input end of the drive circuit 911 is connected to power signals DINP and DINN, an output end of the drive circuit 911 is connected to an input end of the switch circuit 912, and the drive circuit 911 is configured to transmit a data signal to the switch circuit 912. The switch circuit 912 is configured to work in a closed state when an output data signal is at a high level (for example, “1”), a current that is output by the modulation current source 915 is loaded to the laser 913, and the laser 913 sends a first optical signal; in this case, a power of the first optical signal is P₁ (P₁ described in the foregoing embodiment). The switch circuit 912 is configured to work in an open state when an output data signal is at a low level (for example, “0”), a current that is output by the bias current source 914 is loaded to the laser 913, and the laser 913 sends a first optical signal; in this case, a power of the first optical signal is P₀ (P₀ described in the foregoing embodiment). The bias current source 914 is a variable current source, and the modulation current source 915 is a variable current source.

The converting unit 92 includes an MPD 921 and a TIA 922, where a negative electrode of the MPD 921 is grounded, a positive electrode of the MPD 921 is connected to an input end of the TIA 922, and the MPD 921 is configured to convert an optical signal sent by the laser 913 into a current signal; and the TIA 922 converts the current signal, obtained by the MPD 921 through conversion, into a voltage signal, thereby obtaining a first electrical signal.

The monitoring unit 93 includes a filtering circuit 931, an average power monitoring unit 932, and an alternating current power monitoring unit 933, where: an input end of the average power monitoring unit 932 is connected to an output end of the TIA 922, and the average power monitoring unit 932 is configured to calculate an average power of the first electrical signal that is output by the output end of the TIA 922; an input end of the filtering circuit 931 is connected to the output end of the TIA 922, an input end of the alternating current power monitoring unit 933 is connected to an output end of the filtering circuit 931, and the alternating current power monitoring unit 933 is configured to calculate an alternating current power of the first electrical signal that is output by the output end of the TIA 922.

The filtering circuit 931 may be specifically a BPF, a high-pass filter, a coupling capacitor, or the like.

The adjusting unit 94 includes a first comparator 941 and a second comparator 942.

A first input end of the first comparator 941 is connected to an output end of the average power monitoring unit 932, the second input end of the first comparator 941 is connected to a first reference value P₀ used for denoting a target average power that is corresponding to a target extinction ratio and that is indicated by a correspondence between the target average power of the first electrical signal and a target alternating current power of the first electrical signal and the target extinction ratio of the first optical signal, an output end of the first comparator 941 is connected to an adjustment end of the bias current source 914, and the first comparator 941 is configured to adjust an output current of the bias current source 914 to a target bias current, so that the average power calculated by the average power monitoring unit 932 is equal to the first reference value P₀.

A first input end of the second comparator 942 is connected to an output end of the alternating current power monitoring unit 933, the second input end of the second comparator 942 is connected to a second reference value P_{ref} used for denoting the target alternating current power that is corresponding to the target extinction ratio and that is indicated by the correspondence between the target average power of the first electrical signal and the target alternating current power of the first electrical signal and the target extinction ratio of the first optical signal, an output end of the second comparator 942 is connected to an adjustment end of the modulation current source 915, and the second comparator 942 is configured to adjust an output current of the modulation current source 915 to a target modulation current, so that the alternating current power calculated by the alternating current power monitoring unit 933 is equal to the second reference value P_{rof}.

Because the bias current source 914 and the modulation current source 915 respectively output the target bias current and the target modulation current, when the output unit 91 outputs a second electrical signal to the LD 913, and the LD 913 converts the second electrical signal into a second optical signal, an extinction ratio of the second optical signal is the target extinction ratio.

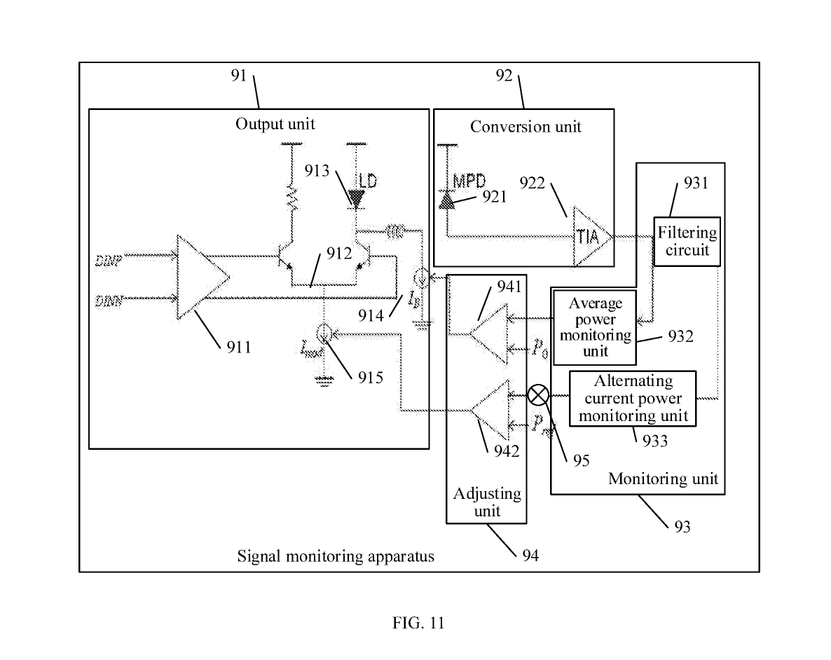

As an optional implementation manner, as shown in FIG. 11, the circuit may further include a multiplying unit 95, where an input end of the multiplying unit 95 is connected to the output end of the alternating current power monitoring unit 933, an output end of the multiplying unit 95 is connected to the first input end of the second comparator 942, the multiplying unit 95 is configured to multiply the alternating current power, output by the alternating current power monitoring unit 933, of the first electrical signal by a target function, to obtain a multiplied alternating current power, where the multiplied alternating current power and the extinction ratio of the first optical signal have a linear relationship.

For example, the correspondence between the target average power of the first electrical signal and the target alternating current power of the first electrical signal and the target extinction ratio of the first optical signal meets the following relationship:

$${P}_{mod} = K \frac{{r}_{e}}{{r}_{e} + 1} .$$

For details about the relational expression, reference may be made to the relationship of the correspondence described in the foregoing method embodiments, and no repeated description is provided herein.

In actual application, a drastic variation of the extinction ratio causes a slight variation of the alternating current power of the first electrical signal. Therefore, when the extinction ratio is relatively large, an error is caused when the relationship, shown in the foregoing expression, between the extinction ratio and the alternating current power of the first electrical signal is used. In an ideal case, a linear relationship between a measurement parameter and a control parameter is relatively good. Specifically, the alternating current power of the first electrical signal may be multiplied by (r_{e,target}+1), that is, the multiplying unit 77 is further configured to multiply the alternating current power, which is output by the output end of the alternating current power monitoring unit 933, of the first electrical signal by the target function (r_{e,target}+1), to obtain a multiplied alternating current power (r_{e,target}+1)·P_{mod}, where

$$( {r}_{e , target} + 1 ) \cdot {P}_{mod} = K \frac{{r}_{e}}{{r}_{e} + 1} ( {r}_{e , target} + 1 ) \approx {Kr}_{e} .$$

That is, (r_{e,target}+1)·P_{mod} and the extinction ratio have a linear relationship, which may be specifically shown in FIG. 5. In this way, the second comparator 942 may adjust the modulation current of the first electrical signal according to the target alternating current power of the first electrical signal and the multiplied alternating current power of the first electrical signal, so that the adjusted modulation current of the first electrical signal is the target modulation current.

In the foregoing technical solution, on the basis of the foregoing embodiment, multiple optional implementation manners are implemented, in all of which precise control on an extinction ratio can be implemented.

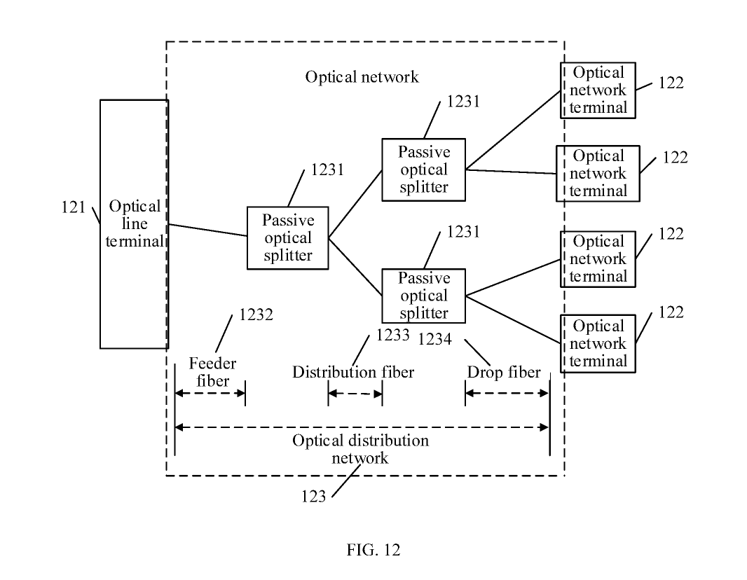

FIG. 12 is a schematic structural diagram of an optical network system according to an embodiment of the present disclosure. As shown in FIG. 12, the optical network system includes an optical line terminal (OLT) 121 and an optical network unit (ONU) 122 or an optical network terminal (ONT) 122, where the optical line terminal 121 is connected to the ONU 122 by using an optical distribution network (ODN) 123, or the optical line terminal 121 is connected to the ONT 122 by using an ODN 123.

The OLT 121 provides a network side interface for the optical network system, and is connected to one or more ODNs 123. The ODN 123 is a passive optical splitter, splits downlink data of the OLT 121 and transmits the downlink data to each ONU 122, and collects uplink data of multiple ONUs 122/ONTs 122 and transmits the uplink data to the OLT 121. The ONU 122 provides a user side interface for the optical network system, and is connected in uplink to the ODN 123. If the ONU 122 directly provides a user port function, for example, an Ethernet user port used by a personal computer (PC) to connect to the Internet, the ONU 122 is referred to as the ONT 122; and the ONU 122 mentioned in the following refers to both the ONU 122 and the ONT 122.

The ODN 123 generally includes three parts: a passive optical splitter 1231, a feeder fiber 1232, a distribution fiber 1233 and a drop fiber 1234, where the distribution fiber 1233 and the drop fiber 1234 may be collectively referred to as a distribution fiber. FIG. 12 is a structural diagram of the ODN 123 that has two levels of optical splitting, and an ODN 123 that has only one level of optical splitting has only a feeder fiber and a drop fiber.

A link from the OLT 121 to the ONU 122 is referred to as a downlink, and a link from the ONU 122 to the OLT 121 is referred to as an uplink. Due to a characteristic of light, downlink data is broadcast to various ONUs 122; and for sending of uplink data of the ONUs 122, the OLT 121 allocates sending intervals, and the sending is performed in a time-division multiplexing manner.

A wavelength of 1310 nm may be used in the uplink of the optical network system, and a wavelength of 1490 nanometer (nm) may be used in the downlink. Light in the uplink and downlink may be transmitted through a same optical fiber, and different optical fibers may also be used for transmission in the uplink and downlink.

The OLT 121 may be the signal monitoring apparatus in any implementation manner in the embodiments shown in FIG. 6 to FIG. 11.

The ONU 122 may also be the signal monitoring apparatus in any implementation manner in the embodiments shown in FIG. 6 to FIG. 11.

In the foregoing technical solution, precise control on an extinction ratio of an optical signal can be implemented on the basis of precise control on a monitored power.

A person of ordinary skill in the art may understand that all or some of the processes of the methods in the embodiments may be implemented by a computer program instructing relevant hardware. The program may be stored in a computer-readable storage medium. When the program runs, the processes of the methods in the embodiments are performed. The foregoing storage medium may include a magnetic disk, an optical disc, a read-only memory (ROM), or a random-access memory (RAM).

What is disclosed above is merely exemplary embodiments of the present disclosure, and certainly is not intended to limit the protection scope of the present disclosure. Therefore, equivalent variations made in accordance with the claims of the present disclosure shall fall within the scope of the present disclosure.

What is claimed is:

1. An optical signal monitoring and control method, comprising:
receiving a first optical signal;
performing optical-to-electrical conversion on the first optical signal to produce a first electrical signal;
outputting the first electrical signal;
monitoring the first electrical signal;
acquiring a monitored power of the first electrical signal;
adjusting the monitored power of the first electrical signal according to a target monitored power of the first electrical signal; outputting a second electrical signal, wherein a second power of the second electrical signal corresponds to the target monitored power;
performing electrical-to-optical conversion on the second electrical signal according to a correspondence between the target monitored power of the first electrical signal and a target extinction ratio of the first optical signal to produce a second optical signal; and
outputting the second optical signal, wherein the second optical signal comprises a second extinction ratio corresponding to the target extinction ratio.

2. The method according to claim 1, wherein before acquiring the monitored power of the first electrical signal, the method further comprises:
amplifying the first electrical signal; and
performing power monitoring on the amplified first electrical signal.

3. The method according to claim 1, wherein acquiring the monitored power of the first electrical signal comprises acquiring a first average power of the first electrical signal and a first alternating current power of the first electrical signal.

4. The method according to claim 3, wherein the target monitored power of the first electrical signal comprises a target average power of the first electrical signal and a target alternating current power of the first electrical signal.

5. The method according to claim 4, wherein adjusting the monitored power of the first electrical signal according to the target monitored power of the first electrical signal comprises:
adjusting a first bias current of the first electrical signal according to the target average power of the first electrical signal and the first average power of the first electrical signal so that the adjusted first bias current of the first electrical signal corresponds to a target bias current; and
adjusting a first modulation current of the first electrical signal according to the target alternating current power of the first electrical signal and the first alternating current power of the first electrical signal so that the adjusted first modulation current of the first electrical signal corresponds to a target modulation current, wherein the outputting the second electrical signal comprises outputting the second electrical signal according to the target bias current and the target modulation current of the first electrical signal,
wherein a second bias current of the second electrical signal corresponds to the target bias current, and
wherein a second modulation current of the second signal corresponds to the target modulation current.

6. The method according to claim 1, wherein the correspondence between the target monitored power of the first electrical signal and the target extinction ratio of the first optical signal is associated with a slope efficiency of the first optical signal.

7. A signal monitoring apparatus, comprising:
a photodiode configured to:
receive a first optical signal;
perform optical-to-electrical conversion on the first optical signal to produce a first electrical signal; and
output the first electrical signal;
a processor coupled to the photodiode and configured to:
monitor the first electrical signal;
acquire a monitored power of the first electrical signal;
adjust the monitored power of the first electrical signal according to a target monitored power of the first electrical signal to produce a second electrical signal; and
output the second electrical signal, wherein a second power of the second electrical signal corresponds to the target monitored power;
a converter coupled to the processor and configured to perform electrical-to-optical conversion on the second electrical signal according to a correspondence between the target monitored power of the first electrical signal and a target extinction ratio of the first optical signal to produce a second optical signal; and
an optical transmitter coupled to the converter and configured to output the second optical signal, wherein the second optical signal comprises a second extinction ratio corresponding to the target extinction ratio.

8. The apparatus according to claim 7, further comprising an amplifier, wherein the amplifier input end of the amplifier is connected to a photodiode output end of the photodiode, wherein an amplifier output end of the amplifier is connected to a monitoring input end of the monitoring unit, and wherein the amplifier is configured to:
amplify the first electrical signal; and
perform power monitoring on the amplified electrical signal.

9. The apparatus according to claim 7, wherein the processor is further configured to:
acquire a first average power of the first electrical signal; and
acquire a first alternating current power of the first electrical signal.

10. The apparatus according to claim 9, wherein the target monitored power of the first electrical signal comprises a target average power of the first electrical signal and a target alternating current power of the first electrical signal.

11. The apparatus according to claim 10, wherein the processor is further configured to:
adjust a first bias current of the first electrical signal according to the target average power of the first electrical signal and the first average power of the first electrical signal so that the adjusted first bias current of the first electrical signal corresponds to a target bias current; adjust a first modulation current of the first electrical signal according to the target alternating current power of the first electrical signal and the first alternating current power of the first electrical signal so that the adjusted first modulation current of the first electrical signal corresponds to a target modulation current; and
output the second electrical signal according to the target bias current and the target modulation current of the first electrical signal, wherein a second bias current of the second signal corresponds to the target bias current, and wherein a second modulation current of the second signal corresponds to the target modulation current.

12. The apparatus according to claim 11, wherein the processor is further configured to:
output the target bias current; and
output the target modulation current.

13. The apparatus according to claim 12, wherein the processor comprises a first comparator, wherein a first comparator input end of the first comparator is connected to the average power output end of the average power monitoring unit, wherein a second comparator input end of the first comparator is connected to a first reference value corresponding to the target average power of the first electrical signal, wherein a first comparator output end of the first comparator is connected to the bias current source, and wherein the first comparator is configured to adjust, according to the target average power of the first electrical signal and the average power of the first electrical signal, a first output current that is output by the bias current source so that the first output current corresponds to the target bias current.

14. The apparatus according to claim 12, wherein the processor comprises a second comparator, wherein a third comparator input end of the second comparator is connected to the alternating current power output end of the alternating current power monitoring unit, a fourth comparator input end of the second comparator is connected to a second reference value corresponding to the target alternating current power of the first electrical signal, wherein a second comparator output end of the second comparator is connected to the modulation current source, and wherein the second comparator is configured to adjust, according to the target average power of the first electrical signal and the first average power of the first electrical signal, a second output current that is output by the modulation current source so that the second output current that is output by the modulation current source corresponds to the target modulation current.

15. An optical network system, comprising:
an optical line terminal;
an optical network unit;
an optical distribution network connecting the optical line terminal to the optical distribution network,
wherein the optical line terminal comprises a first signal monitoring apparatus,
wherein the optical network unit comprises a second monitoring apparatus, and
wherein each of the first signal monitoring apparatus and the second signal monitoring apparatus comprises:
a photodiode configured to:
receive a first optical signal;
perform optical-to-electrical conversion on the first optical signal to produce a first electrical signal; and
output the first electrical signal;
a processor configured to:
monitor the first electrical signal;
acquire a monitored power of the first electrical signal;
adjust the monitored power of the first electrical signal according to a target monitored power of the first electrical signal to produce a second electrical signal; and
output the second electrical signal, wherein a second power of the second electrical signal corresponds to the target monitored power; and
a converter configured to perform electrical-to-optical conversion on the second electrical signal according to a correspondence between the target monitored power of the first electrical signal and a target extinction ratio of the first optical signal to produce a second optical signal; and
an optical transmitter configured to output the second optical signal, wherein the second optical signal comprises a second extinction ratio corresponding to the target extinction ratio.

16. The optical network system according to claim 15, further comprising an amplifier, wherein the amplifier input end of the amplifier is connected to a photodiode output end of the photodiode, wherein an amplifier output end of the amplifier is connected to a monitoring input end of the monitoring unit, and wherein the amplifier is configured to:
amplify the first electrical signal; and
perform power monitoring on the amplified electrical signal.

17. The optical network system according to claim 15, wherein the processor is further configured to:
acquire a first average power of the first electrical signal; and
acquire a first alternating current power of the first electrical signal.

18. The optical network system according to claim 17, wherein the target monitored power of the first electrical signal comprises a target average power of the first electrical signal and a target alternating current power of the first electrical signal.

19. The optical network system according to claim 18, wherein the processor is further configured to:
adjust a first bias current of the first electrical signal according to the target average power of the first electrical signal and the first average power of the first electrical signal so that the adjusted first bias current of the first electrical signal corresponds to a target bias current; adjust a first modulation current of the first electrical signal according to the target alternating current power of the first electrical signal and the first alternating current power of the first electrical signal so that the adjusted first modulation current of the first electrical signal corresponds to a target modulation current; and
output the second electrical signal according to the target bias current and the target modulation current of the first electrical signal, wherein a second bias current of the second signal corresponds to the target bias current, and wherein a second modulation current of the second signal corresponds to the target modulation current.

20. The optical network system according to claim 19, wherein the processor is further configured to:
output the target bias current; and
output the target modulation current.
